(19) United States
(12) Patent Application Publication
(10) Pub. No.: US 2009/0212143 A1
(43) Pub. Date: Aug. 27, 2009

(54) Palm-operated mortar-and-pestle

(76) Inventor: Eric Y. Teng, Gold River, CA (US)

Correspondence Address: Eric Teng;Nextrend Products, Suite A-8, 11300 Coloma Road, Gold River, CA, 95670, US

(21) Appl. No.: 12/322,404

(22) Filed: Feb. 2, 2009

Related U.S. Application Data
(60) Provisional application No. 61/067,084, filed on Feb. 25, 2008.

(51) Int. Cl. B02C 19/08

(52) U.S. Cl. 241/169.2; 241/199.9

(57) ABSTRACT

The traditional mortar-and-pestle consists of a bowl-shaped container and a rod-shaped pestle. During use, a user holds the pestle in his/her hand and uses it to pound and grind the raw ingredients such as fresh herbs and whole spices to reduce them into fine particles. This invention proposes a new design with a stubby mushroom-shaped pestle having a dome-shaped bottom profile which correlates closely (i.e. closely fitting in form or outline with each other) with the profile of a dome-shaped inside bottom of the mortar. This novel design allows a user to simply press down on the “mushroom head” of the pestle and twirl the pestle inside the mortar for it to sufficiently break down the raw ingredients into fine particles without hard pounding, or the associated noise and splashing.

### CROSS REFERENCE TO RELATED APPLICATIONS

This application claims the benefit of U.S. Provisional Application No. 61067084022508 filed Feb. 23, 2008.

### REFERENCES CITED

U.S. Pat. No. 4,967,971 Smith

U.S. Pat. No. 4,348,950 Harris

U.S. Pat. No. 4,341,356 Hiott

U.S. Pat. No. 2,892,595 Tupper

U.S. Pat. No. D490,160 Sorenson

U.S. Pat. No. D543,634 Lindstrom

### BACKGROUND

1. Field of Invention

The present invention pertains to a class of food processing device commonly known as mortar-and-pestle which may also be used for grinding of pills for medical purposes.

2. Description of Prior Art

The mortar-and-pestle is one of the earliest cooking implements used by pre-historic humans to break down hard, dried food such as corn, rice, wheat to turn such into a powder form suitable for further processing into food for human consumption. Such early mortar-and-pestles are by and large made with heavy solid rock material. In the modern society, food powders in the form of flour etc. are readily available as commercial products and the present day mortar-and-pestle is mainly used to break down the softer ingredients such as fresh herbs and dried spices. So the mortar-and-pestles being sold on the market are substantially smaller and are often made of lighter material such as ceramic or thin metal.

The common feature that all present day mortar-and-pestles share is that the “pestle” is a rod designed to be hand-gripped by a user. Thus it usually has a fairly narrow upper portion for hand-gripping, or a narrow rod with a larger knob on top for the same purpose. The bottom of the pestle is usually larger than its upper portion for smashing and grinding of the ingredients contained within the mortar. During use, the user holds the pestle in his/her hand, then use a repeated pounding action to strike the ingredients within the mortar to break them down into smaller particles. After this the user continues to use the bottom of the pestle to grind the small particles against the bottom of the mortar to further pulverize them. Sometimes a liquid ingredient such as olive oil is added at this stage to turn the ingredient into a semi-liquid.

It can be seen that a traditional mortar-and-pestle always requires hard hand-pounding. This is always an unpleasant action for most people, and sometimes it can be difficult or even impossible for people with health problems. Additionally, hard pounding of the mortar-and-pestle creates extremely unpleasant noise that can border on the unbearable (especially for metal or ceramic units), and can often cause messy spills of the ingredient whether solid or liquid.

Examples of such design can be seen in inventions presented in U.S. Pat. Nos. D543,634 and D490,160 and such are commonly available on the market.

Despite such noted disadvantages, mortar-and-pestle remains a popular and useful culinary tool for use in the kitchen.

### BACKGROUND OF INVENTION—OBJECTS AND ADVANTAGES

The objects and advantages of the present invention are:
a) Palm operation of it is easy, quick and fin to use;
b) It requires no hard pounding;
c) It creates no unpleasant noise during use;
d) It minimizes splashing of ingredients during use;
e) It is compact, light and attractive;
f) If required it can be used in the traditional way as other mortar-and-pestle to pound down hard ingredients;
g) It can be mass-produced efficiently and economically by simple injection molding.

Still further objects and advantages will become apparent from a consideration of the ensuing descriptions and drawings.

### SUMMARY OF THE INVENTION

A modernized version of the traditional mortar-and-pestle is presented herein. The pestle is in the shape of a stubby mushroom with a relatively flat and large head designed to comfortably fit a human palm, and a dome-shaped bottom. The mortar is in the shape of a bowl with a dome-shaped bottom. The lower end of the pestle has a vertical cross-sectional profile that correlates closely with the cross-sectional profile of the interior of the mortar. A mortar-and-pestle of this design would enable it to be used by a user pressing down on its mushroom head with his/her palm while twirling the pestle inside the mortar to efficiently grind down the ingredients contained within the mortar in preparing sauces, salad dressings, marinating rubs or to pulverize pills for medical purposes etc.

### DRAWINGS—FIGURES

FIG. 1 shows how the invention can be operated by a user's palm

FIG. 2 shows the relative positioning of the mushroom-shaped pestle within the confinement of the bowl-shaped mortar

### DRAWINGS—REFERENCE NUMERALS

10 The mushroom-shaped pestle

20 The bowl-shaped mortar

30 Ingredients (herbs, spices, medical pills etc.) for processing

40 Convex flat top of the pestle

50 Locus of rotation of the pestle

60 Dome-shaped cross-sectional profile of the lower portion of the pestle

70 Dome-shaped cross-sectional profile of the interior of the mortar showing close correlation with 60 above

### DETAILED DESCRIPTION OF THE INVENTION—PREFERRED EMBODIMENT

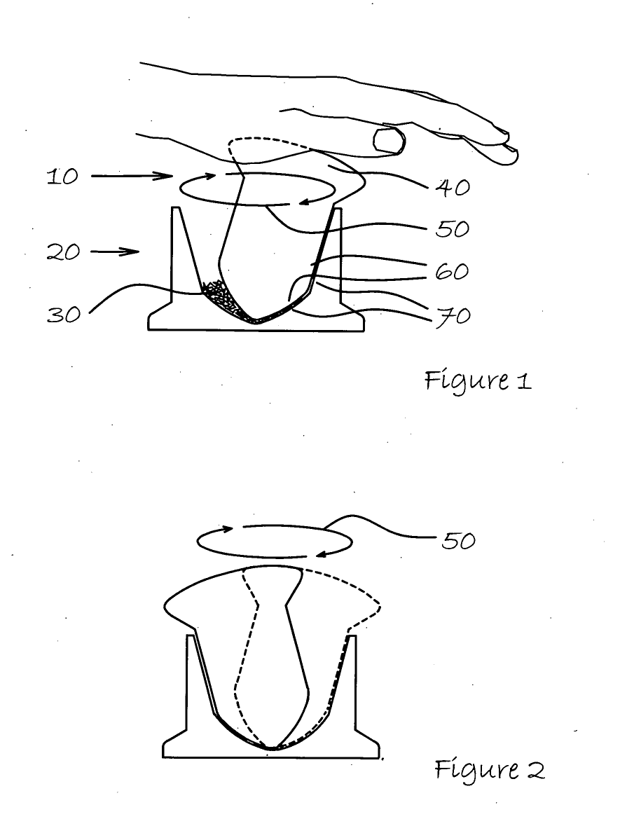

In the preferred embodiment as shown in FIG. 1 (and FIG. 2), the set of mortar-and-pestle has a mushroom-shaped pestle 10 and a bowl-shaped mortar 20 both with circular horizontal sections. The pestle is such that it has a relatively large and flat convex top 40 designed for the placement of a user's palm. The lower end of the pestle 10 has a dome-shaped surface having somewhat of an apex at its tip. The mortar 20 has an inverted dome-shaped sunken surface 60 also with somewhat of an apex at its center. The bottom of the mortar has a vertical cross-sectional profile (i.e. outline or form) 70 that corresponds or correlates closely with the vertical cross-sectional profile of the lower portion of the pestle 60. It is also shown that both the pestle and the mortar have a dome-shaped bottom having vertical circular sections on their respective surfaces.

During use, the user can exert a downward force and a rotational force onto the pestle by pressing down on the convex top 40 while pushing the pestle around. The pestle is then forced to lean against the sidewall of the mortar while it is being twirled or rotated to circle around within the confinement of the bowl in a circular sweeping motion illustrated by its locus 50.

Both the horizontal cross-sections of the pestle and that of the mortar are circular with different radii. The part of the pestle at the same height with that of the top brim of the mortar should be of a considerably smaller radius than that of the later to allow the pestle to be able to swirl or rotate around inside of the mortar while leaning against the sidewall of the interior of the mortar as illustrated in FIG. 2.

As the pestle is being pressed downward and pushed to circle around the mortar along locus 50, the pestle would be force to lean against the sidewall of the mortar during this process. Since the vertical cross-sectional profile 70 of the lower portion of the mortar closely correlates with the profile 60 of the lower portion of the pestle, it can be seen that there is a “contact line” between the two that extends radially upwards from the very bottom of the mortar. As the pestle is twirled or rotated within the mortar, this contact line actually sweeps the entire interior of the mortar in a circular motion in the manner that the second or minute or hour hand of a clock sweeps the entire surface of the clock at each 360 degree turn. This sweeping contacting line under the pressure exerted by a user's palm can thus serve to grind up any solid ingredients 30 within its contained inside the mortar. In effect, all the solid ingredients would be ground once at each sweep or complete rotation of the pestle under pressure. A user therefore can control the fineness of the grind by controlling the downward force exerted by his/her palm, as well as the duration of the process.

It can be seen that during normal usage, there would not be any pounding involved unlike in the case of using a set of traditional mortar-and-pestle. So the unpleasant noise associated with such can be avoided and the splashing of ingredients can also be minimized.

In the case of very hard raw ingredients such as cinnamon or star anise, this invention can also be used in the same manner as using a traditional mortar-and-pestle to pulverize such ingredients by hard pounding. Therefore the invention can be seen to offer a means for silent, efficient, fun, and quick palm-operated grinding of common fresh herbs and spices, as well as the option to deal with the hardest of the ingredients by hard pounding by hand in the traditional manner.

The above description describes the preferred embodiment having a corresponding or correlating dome-shaped profile for both the pestle and the mortar. However, other correlating profiles can also achieve the same end result. For example, the two can be in the shape of a cone having a straight (rather than bowed out) vertical cross-sectional profile, or can have a correlating step or cascaded profile. Such variations would also be possible to be used in arriving at a satisfactory design for this invention.

While the preferred embodiment of the present invention has been described in the specifications and drawings, it should be apparent that other modifications and adaptations can be readily achieved by those skilled in the art. Therefore the scope of this invention is hereby set forth and defined by the following Claims.

What is claimed is:

1) A device for processing solid ingredients such as herbs, spices and medical pills into fine particles comprising a palm-operable circular male unit having a top surface shaped for placement of a human palm, and a bowl-shaped circular female unit; the exterior of the lower portion of said male unit having a vertical cross-sectional first profile, the lower portion of the interior of said female unit having a vertical cross-sectional second profile; said first and second profiles being closely correlating with each other; said male unit can be inserted into said female unit to lean against the circular sidewall of said female unit allowing said first and second profiles to interact; whereby said solid ingredients can be reduced into fine particles therein.

2) Said device of claim 1, said male unit being in the shape of a mushroom having a large convex top, a main body, and a progressively smaller bottom end.

3) Said device of claim 1 made of material selected from the group thermo plastic, wood, ceramic, metal, glass, and rock.

4) A device for the processing of solid materials such as herbs, spices, medical pills and the like comprising: a male unit having a main body with a circular horizontal cross-section with a first radius, and a vertical cross-sectional first profile at its lower portion; a female unit having a circular horizontal interior cross-section having a second radius at its interior top brim, and a vertical cross-sectional second profile at its lower interior portion; said first radius being substantially smaller than said second radius allowing said male unit to freely lean against the entire circular sidewall of said female unit and be freely rotated around the peripheral of the interior of said female unit; said first and second profiles correlate closely with each other allowing close contact therein between, whereby said contact substantially defines a contacting line extending radially upwards from the bottom of said male and female unit; said contacting line substantially sweeps the entire 360 degree surface of the lower portion of said female unit at each complete rotation of said male unit inside said female unit; whereby solid ingredients can be processed wherein at said contacting line when downward and rotational manual force is applied onto said male unit forcing said male unit to swirl around within said female unit.

5) Device of claim 4, said manual force being applied by a user's palm.

6) Said device of claim 4, said male unit being in the shape of a mushroom having a large convex top, a main body, and a progressively smaller bottom end.
